(19) United States
(12) Patent Application Publication
(10) Pub. No.: US 2016/0179255 A1
(43) Pub. Date: Jun. 23, 2016

(54) TOUCH DISPLAY DEVICE AND NOISE-SHIELDING METHOD FOR TOUCH DISPLAY DEVICE

(71) Applicant: CHUNGHWA PICTURE TUBES, LTD., Taoyuan (TW)

(72) Inventors: Wen-Shan Yang, Taoyuan (TW); Wei-Yen Chiu, Taoyuan (TW)

(21) Appl. No.: 14/682,134

(22) Filed: Apr. 9, 2015

(30) Foreign Application Priority Data
Dec. 19, 2014 (TW) 103144604

(51) Int. Cl. G06F 3/047; G09G 5/00

(52) U.S. Cl. CPC G06F 3/047; G09G 5/003; G09G 2300/04

(57) ABSTRACT

A touch display device includes a display panel, a conductive layer on the display panel, an insulation layer on the conductive layer, and a touch panel on the insulation layer. The insulation layer has a first via. The touch panel includes a ground pad located at a peripheral region thereof The touch panel is connected to an external circuit through a flexible printed circuit board. The conductive layer is electrically connected to the ground pad through the first via of the insulation layer, but not directly connected to the flexible printed circuit board. A noise-shielding method for touch display device is also provided.

### CROSS-REFERENCES TO RELATED APPLICATIONS

This non-provisional application claims priority under 35 U.S.C. §119(a) on Patent Application No. 103144604 filed in Taiwan, R.O.C. on 2014 Dec. 19, the entire contents of which are hereby incorporated by reference.

### BACKGROUND

1. Technical Field

The instant disclosure relates to a touch display device and a noise-shielding method for touch display device, in particular, to an embedded touch display device and noise-shielding method therefor.

2. Related Art

Recently, with the continuous optimization of the human computer interfaces, touch operations have become a main stream for manipulating user interfaces. With the touch technology, users no longer need to press physical keys. Instead, users may use one finger or a touch pen to contact the screen of an electronic device directly and operate the device based on human instinct.

Also, with the advancement in touch technology, display panels with touch technology are largely adopted into many electronic devices in order to get rid of the physical keyboards or buttons for space saving, thus the electronic devices benefit from convenient operation, small size, and large viewing area. Exemplary devices may include tablets, notebooks, smart phones, etc.

Generally, a conventional touch display device mainly includes a touch panel and a display panel. Based on the structures and the manufacturing methods, touch display devices can be roughly divided into out-cell touch display devices and embedded touch display devices. The embedded touch display devices may be further divided into on-cell touch display devices and in-cell touch display devices. For a conventional on-cell touch display device, the touch sensor is assembled to the backside of the color filter. While for a conventional in-cell touch display device, the touch sensor is directly configured in the liquid crystal display.

For a conventional embedded touch display device, the touch sensor and the thin film transistor substrate (TFT substrate) of the display panel are too closed, such that the signals generated from the touch sensor and the TFT substrate of the display panel would interfere with each other during operation, thus the sensitivity of the touch display device is influenced.

### SUMMARY

Therefore, the instant disclosure provides an improved on-cell touch display device to prevent the interference between the touch sensor and the TFT substrate of the display panel which would influence the sensitivity of the touch display device.

In one implementation aspect according to the instant disclosure, a touch display device is provided and comprising a display panel, a conductive layer, an insulation layer, and a touch panel. The conductive layer is on the display panel, the insulation layer is on the conductive layer, and the touch panel is on the insulation layer. The insulation layer defines a first via therethrough. The touch panel comprises a ground pad, and the ground pad is located at a peripheral region of the touch panel and electrically connected to the conductive layer through the first via.

In one implementation aspect, the ground pad is on the insulation layer.

In one implementation aspect, the first via corresponds to the ground pad, such that the ground pad is electrically connected to the conductive layer through the first via.

In one implementation aspect, the touch panel further comprises a conducting portion on the ground pad.

In one implementation aspect, the ground pad defines an opening therethrough and the opening corresponds to the first via.

In one implementation aspect, the size of the opening is equal to the size of the first via.

In one implementation aspect, the touch panel further comprises an isolated layer and an electrode layer. Wherein, the isolated layer is on the ground pad, and the isolated layer defines a second via therethrough, and the second via corresponds to the opening. Wherein, the electrode layer is on the isolated layer, and the electrode layer comprises a conducting portion corresponding to the ground pad, and the conducting portion is electrically connected to the ground pad and the conductive layer through the second via, the opening, and the first via.

In one implementation aspect, the size of the second via of the isolated layer is equal to the size of the first via of the insulation layer.

In one implementation aspect, the conductive layer entirely overlaps on the display panel.

In one implementation aspect according to the instant disclosure, a noise-shielding method for touch display device is provided and comprising forming a conductive layer on a display panel, forming an insulation layer on the conductive layer, defining an adapting portion for a ground pad on the insulation layer, removing parts of the insulation layer corresponding to the adapting portion to form a first via through the insulation layer, and forming the ground pad on the insulation layer. Wherein, the ground pad contacts the conductive layer through the first via, so that the conductive layer is grounded.

In one implementation aspect according to the instant disclosure, a noise-shielding method for touch display device is provided and comprising forming a conductive layer on a display panel, forming an insulation layer on the conductive layer, forming a ground pad on the insulation layer, wherein the ground pad defines an opening therethrough, forming an isolated layer on the ground pad, removing parts of the isolated layer corresponding to the opening of the ground pad and parts of the insulation layer corresponding to the opening of the ground pad so as to form a first via through the insulation layer and to form a second via through the isolated layer, and forming an electrode layer on the isolated layer. Wherein, the electrode layer comprises a conducting portion corresponding to the ground pad, the conducting portion is electrically connected to the ground pad and the conductive layer through the second via, the opening, and the first via, so that the conductive layer is grounded.

In one implementation aspect, the conductive layer entirely overlaps on the display panel.

Detailed description of the characteristics and the advantages of the disclosure is shown in the following embodiments, the technical content and the implementation of the disclosure should be readily apparent to any person skilled in the art from the detailed description, and the purposes and the advantages of the disclosure should be readily understood by any person skilled in the art with reference to content, claims and drawings in the disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 is schematic top view of a touch display device according to a first embodiment of the instant disclosure;

FIG. 2 is a cross-sectional view taken along line 1-1 of FIG. 1;

FIG. 3a is a partial cross-sectional view of a ground pad taken along line 2-2 of FIG. 1;

FIG. 3b is a partial cross-sectional view of a touch signal transmitting pad taken along line 2-2 of FIG. 1;

FIG. 4a is a partial cross-sectional view showing an adapting portion for a ground pad according to a second embodiment of the instant disclosure; and

FIG. 4b is a schematic top view of the ground pad according to the second embodiment of the instant disclosure.

### DETAILED DESCRIPTION

The touch display device according to the instant disclosure may be in a double layer sensor (DLS) configuration, but embodiments are not limited thereto. That is, the touch display device according to the instant disclosure may be in a one layer sensor (OLS) configuration.

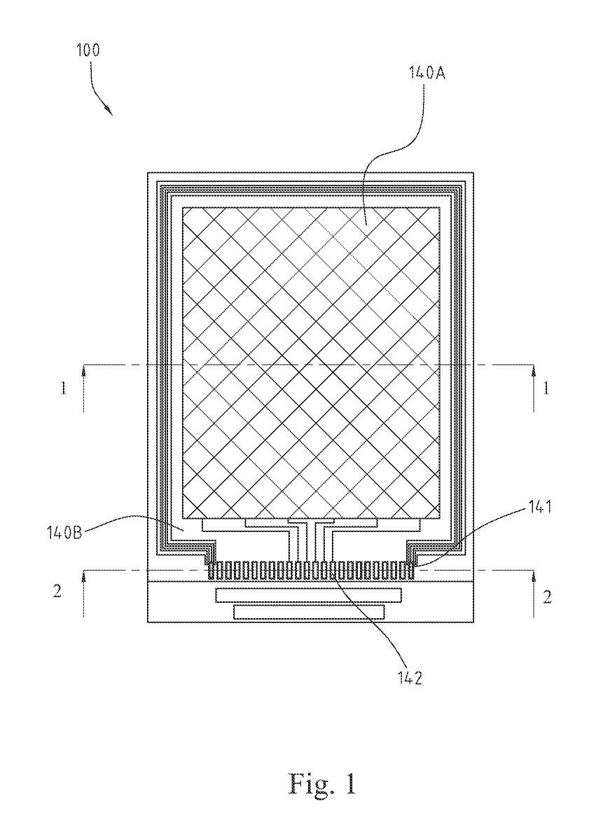

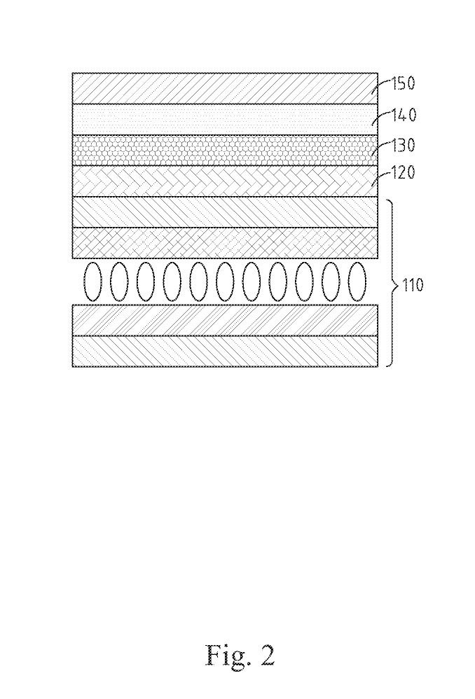

Please refer to FIG. 1 and FIG. 2. FIG. 1 is schematic top view of a touch display device 100 according to a first embodiment of the instant disclosure, and FIG. 2 is a cross-sectional view taken along line 1-1 of FIG. 1.

The touch display device 100 comprises a touch panel 140 and a display panel 110. The touch panel 140 has a touch region 140A and a peripheral region 140B. In some embodiments, the touch region 140A is the display region of the screen of the touch display device 100, and is provided for users to input operations via touching in the touch region 140A. The touch signals received by the touch region 140A are transmitted to a touch integrated circuit (touch IC), such as a control circuit, via a flexible printed circuit board (FPCB, not shown) for further processing.

The peripheral region 140B of the touch panel 140 is the place where the screen frame of the screen is to be configured to, and the screen frame is provided for accommodating the layout of the touch display device 100. In other words, the layout of the touch display device 100 is hided within the screen frame. In this embodiment, the touch panel 140 is carried out by a projective capacitive touch panel.

The display panel 110 is provided for display, for example, multimedia information. In this embodiment, the display panel 100 is carried out by thin-film transistors (TFT).

To prevent the mutual interference between touch signals received by the touch panel 140 and display signals transmitted by the TFT, in the instant disclosure, a conductive layer 120 is between the touch panel 140 and the display panel 110 as a shield for preventing the mutual interference between the touch signals and the display signals. In addition, since the touch panel 140 comprises a metal layer 146 having metal wires for transmitting touch signals, an insulation layer 130 is between the conductive layer 120 and the touch panel 140 to prevent the electrical conduction between the conductive layer 120 and the metal layer 146 of the touch panel 140.

Here, the conductive layer 120 and the insulation layer 130 are formed on the display panel 110, and the insulation layer 130 is on the conductive layer 120. Then, the touch panel 140 is configured on the insulation layer 130. Finally, a protecting layer 150 may be further configured on the touch panel 140 to protect the touch panel 140.

In addition, in this embodiment, the touch panel 140 is formed on the insulation layer 130 by a film forming process.

In one implementation of the first embodiment, the conductive layer 120 entirely overlaps on the display panel 110 to perform complete shielding performance The conductive layer 120 may be made of, but not limited to, indium tin oxide (ITO). Also, the conductive layer 120 may be made of other materials having proper conductivities.

The insulation layer 130 may be made of, but not limited to, silicon dioxide. Also, the insulation layer 130 may be made of other materials having proper insulation performances, such as acrylic resin, silicon nitride or silicon oxynitride.

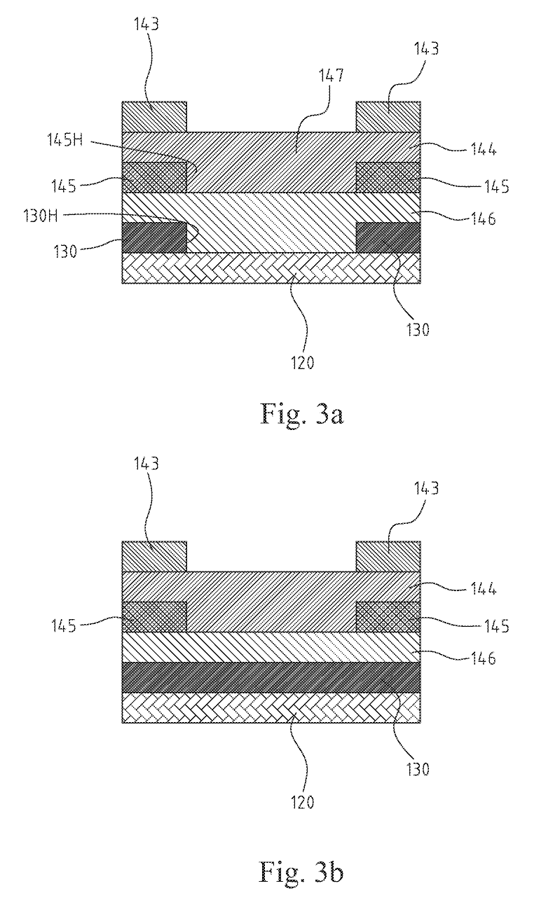

FIG. 3a is a partial cross-sectional view of a ground pad 141 taken along line 2-2 of FIG. 1, and FIG. 3b is a partial cross-sectional view of a touch signal transmitting pad 142 taken along line 2-2 of FIG. 1.

The touch panel 140 comprises a ground pad 141 and a touch signal transmitting pad 142 located at the peripheral region 140B thereof. The touch panel 140 utilizes the touch signal transmitting pad 142 for touch signal transmission. The ground pad 141 and the touch signal transmitting pad 142 are both on the conductive layer 120 and on the insulation layer 130. The ground pad 141 is provided to discharge statics and noises to the ground potential. In order to conduct the conductive layer 120 at an adapting portion for the ground pad 141 to ground, the insulation layer 130 defines a first via 130H therethrough, and the ground pad 141 is electrically connected to the conductive layer 120 through the first via 130H, so that the conductive layer 120 is grounded. That is, in this embodiment, the conductive layer 120 does not electrically contact the FPCB. Instead, the conductive layer 120 is electrically connected to the ground pad 141 of the touch panel 140 for grounding, thus providing noise-shielding functions.

When the touch panel 140 is forming, parts of the insulation layer 130 is removed by lithography. Therefore, at least one first via 130H is formed through the insulation layer 130. And then, the ground pad 141 electrically contacts the conductive layer 120 through the first via 130H, so that the conductive layer 120 is grounded.

Moreover, the touch panel 140 comprises a metal layer 146, an isolated layer 145, an electrode layer 144, and a protecting layer 143. The metal layer 146 has a certain metal wiring layout for transmitting the touch signals from the electrode layer 144 to the touch signal transmitting pad 142. The ground pad 141 is located at a certain position of the metal layer 146, and the position where the ground pad 141 is located at depends on the metal wiring layout of the metal layer 146. The first via 130H of the insulation layer 130 corresponds to the ground pad 141. Therefore, when the metal layer 146 is forming, metal materials would be fed into the first via 130H, so that the ground pad 141 is electrically connected to the conductive layer 120 to allow the conductive layer 120 electrically connecting to the ground potential.

Here, the metal layer 146 may be formed by, but not limited to, chemical vapor deposition methods or physical vapor deposition methods.

Besides, in order to connect the electrode layer 144 with the metal layer 146, the display panel 140 further comprises a conducting portion 147 at the electrode layer 144 on the ground pad 41. Here, the electrode layer 144 is electrically connected to the metal layer 146 through the conducting portion 147.

The manufacturing process of the touch panel 140 having the adapting portion for the ground pad 141 is described as below. Firstly, the conductive layer 120 is formed on the display panel 110. And then, the insulation layer 130 is formed on the conductive layer 120 and the adapting portion for the ground pad 141 is defined on the insulation layer 130. Next, parts of the insulation layer 130 located at the adapting portion for the ground pad 141 is removed by lithography to form the first via 130H. Finally, the metal layer 146, the isolated layer 145, the electrode layer 144, and the protecting layer 143 are formed in order on the insulation layer 130 and the conductive layer 120.

Based on this, when the ground pad 141 is formed on the insulation layer 130, the ground pad 141 contacts the conductive layer 120 and electrically connects the conductive layer 120 with the ground potential. Therefore, in this embodiment, the insulation layer 130 having certain patterns thereon is mated with a specified mask, and other layers mate with respective masks.

Compared with the ground pad 141, the touch signal transmitting pad 142 of the metal layer 146 is provided to receive and transmit touch signals and is not electrically connected to the ground potential. In this embodiment, the insulation layer 130 where the touch signal transmitting pad 142 is located at does not have to be removed.

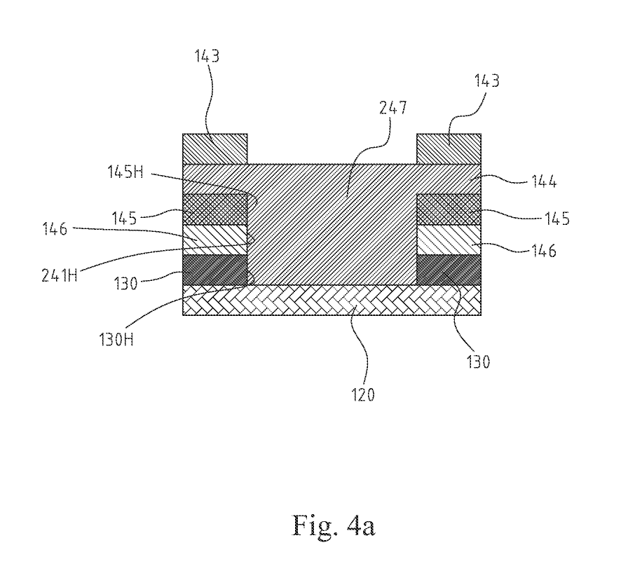

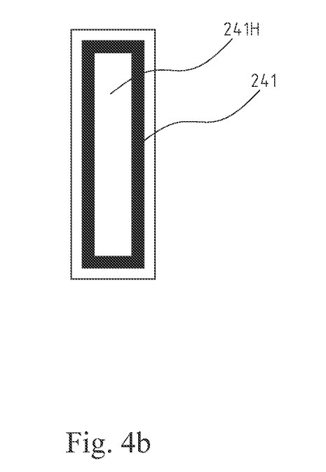

Please refer to FIG. 4a, illustrating a partial cross-sectional view showing an adapting portion for a ground pad 241 according to a second embodiment of the instant disclosure. The structure of the second embodiment is approximately the same as that of the first embodiment, except that the structure of the adapting portion in the second embodiment is different from that in the first embodiment. The purpose of the second embodiment is to provide a ground pad 241 having an enclosed rectangular cavity to replace the ground pad 141 with rectangular shaped shown in the first embodiment. In other words, the center of ground pad 241 defines an opening 241H therethrough when the ground pad 241 is forming on the insulation layer 130. Therefore during the touch panel manufacturing process, by proper process parameter adjustments, the isolated layer 145 and the insulation layer 130 may be simultaneously etched in the lithography procedure for manufacturing the isolated layer 145, such that the first via 130H is defined through the insulation layer 130 and a second via 145H is defined through the isolated layer 145. As a result, the isolated layer 145 and the insulation layer 130 can share one mask with each other, and the isolated layer 145 and the insulation layer 130 do not need respective masks. As compared with the first embodiment, in the second embodiment, the ground pad 241 defines the opening 241H therethrough. Therefore, the position of the first via 130H defined through the insulation layer 130 corresponds to the position of the opening 241H of the ground pad 241. In addition, both the size and the outline of the first via 130H are approximately the same as that of the opening 241H.

Additionally, in the second embodiment, the position of the second via 145H of the isolated layer 145 corresponds to the position of the opening 241H. Likewise, both the size and the outline of the second via 145H are approximately the same as that of the opening 241H and that of the first via 130H. In this embodiment, the ground pad 241 is electrically connected to the conductive layer 120 through the conducting portion 247 passing through the first via 130H, the opening 241H, and the second via 145H.

As compared with the first embodiment, in this embodiment, the ground pad 241 formed on the insulation layer 130 defines the opening 241H through the center thereof at the beginning. And then, after the isolated layer 145 is formed on the ground pad 241, lithography is applied to etch parts of the isolated layer 145 corresponding to the opening 241H of the ground pad 241 and parts of the insulation layer 130 corresponding to the opening 241H of the ground pad 241 so as to define the second via 145H through the isolated layer 145 and define the first via 130H through the insulation layer 130. Here, the conducting portion 247 of the electrode layer 144 electrically contacts the ground pad 241 and the conductive layer 120 through the second via 145H, the opening 241H, and the first via 130H, so that the conductive layer 120 is electrically connected to the ground potential.

Please refer to FIG. 4b, illustrating a schematic top view of the ground pad 241 according to the second embodiment of the instant disclosure. As shown, in the second embodiment, the center of the ground pad 241 is hollowed. That is, the ground pad 241 has an enclosed rectangular cavity (i.e., the opening 241H). As compared with the first embodiment, in the second embodiment since the insulation layer 130 is etched along with the etching of the isolated layer 145 during the lithography, the isolated layer 145 and the insulation layer 130 share one mask with each other, and the isolated layer 145 and the insulation layer 130 do not need respective masks.

According to the touch display device 100, the conductive layer 120 is bonding with the FPCB by one time, and the conductive layer 120 of the touch display device 100 can be completely grounded through the ground pad 241 for providing shielding performance.

According to the instant disclosure, a noise-shielding method for touch display device is also provided. As shown in FIG. 1 and FIG. 3a, firstly chemical vapor deposition or physical vapor deposition is utilized to form a conductive layer 120 on a display panel 110. Then, an insulation layer 130 is formed on the conductive layer 120. Next, an adapting portion for a ground pad 141 is predefined on the insulation layer 130 based on the wiring layout of the touch display device 100. Thereafter, parts of the insulation layer 130 corresponding to the adapting portion are removed so as to define a first via 130H through the insulation layer 130. Finally, the ground pad 141 is formed on the adapting portion of the insulation layer 130, and the ground pad 141 is allowed to contact the conductive layer 120 through the first via 130H, so that the conductive layer 120 is grounded. In this method, the conductive layer 120 entirely overlaps on the display panel 110 so as to perform proper shielding function. Therefore, signals generated from the display panel 110 do not interference with that from the touch panel 140 during the operation of the touch display device 100.

According to the instant disclosure, another noise-shielding method for touch display device is also provided. As shown in FIG. 1, FIG. 4a, and FIG. 4b, firstly chemical vapor deposition or physical deposition is utilized to form a conductive layer 120 on a display panel 110. Then, an insulation layer 130 is formed on the conductive layer 120. Next, a ground pad 241 is formed on the insulation layer 130, and the ground pad 241 defines an opening 241H therethrough. Thereafter, an isolated layer 145 is formed on the ground pad 241. And then, parts of the isolated layer 130 corresponding to the opening 241H of the ground pad 241 and parts of the insulation layer 130 corresponding to the opening 241H of the ground pad 241 are removed so as to define a first via 130H through the insulation layer 130 and to define a second via 145H through the isolated layer 145. Finally, an electrode layer 144 is formed on the isolated layer 145, and the electrode layer 144 comprises a conducting portion 247 corresponding to the ground pad 241. Wherein, the conducting portion 247 is electrically connected to the ground pad 241 and the conductive layer 120 through the second via 145H, the opening 241H, and the first via 130H, so that the conductive layer 120 is grounded. In this method, the conductive layer 120 entirely overlaps on the display panel 110 so as to perform proper shielding function. Therefore, signals generated from the display panel 110 do not interference with that from the touch panel 140 during the operation of the touch display device 100. Besides, the size and the outline of the second via 145H are approximately the same as that of the opening 241H and that of the first via 130H. The ground pad 241 located at the metal layer 146 is designed to have an enclosed rectangular cavity to allow the isolated layer 145 and the insulation layer 130 share the same mask for patterning, such that the cost for mask design can be reduced.

Based on the above, according to the touch display device and the noise-shielding method for touch display device, conductive layer and insulation layer are formed between the display panel and the touch panel, and the first via is defined through the insulation layer, such that the conductive layer is electrically connected to the ground pad of the touch panel through the first via, enabling the conductive layer grounding completely and performing proper shielding. Therefore, the influence of external noises toward the touch display device can be reduced, the interference between the touch signals and the display signals within the touch display device can be improved, and the possibility of the occurrence of electrostatic discharge (ESD) can be effectively reduced. Moreover, since the conductive layer of the touch display device is well grounded, a ground ring may not have to be assembled along the periphery of the touch display device. As a result, the proportion of the display area over the area of the touch display device is increased, thus satisfying the narrow frame requirements.

While the instant disclosure has been described by way of example and in terms of the preferred embodiments, it is to be understood that the invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A touch display device, comprising:
a display panel;
a conductive layer on the display panel;
an insulation layer on the conductive layer, the insulation layer defines a first via therethrough; and
a touch panel on the insulation layer, the touch panel comprising a ground pad, wherein the ground pad is located at a peripheral region of the touch panel, and the ground pad is electrically connected to the conductive layer through the first via.

2. The touch display device according to claim 1, wherein the ground pad is on the insulation layer.

3. The touch display device according to claim 1, wherein the first via corresponds to the ground pad, such that the ground pad is electrically connected to the conductive layer through the first via.

4. The touch display device according to claim 3, wherein the touch panel further comprises a conducting portion on the ground pad.

5. The touch display device according to claim 1, wherein the ground pad defines an opening therethrough and the opening corresponds to the first via.

6. The touch display device according to claim 5, wherein the size of the opening is equal to the size of the first via.

7. The touch display device according to claim 5, wherein the touch panel further comprises:
an isolated layer on the ground pad, the isolated layer defines a second via therethrough and the second via corresponds to the opening; and
an electrode layer on the isolated layer, the electrode layer comprises a conducting portion, wherein the conducting portion corresponds to the ground pad, and the conducting portion is electrically connected to the ground pad and the conductive layer through the second via, the opening, and the first via.

8. The touch display device according to claim 7, wherein the size of the second via of the isolated layer is equal to the size of the first via.

9. The touch display device according to claim 8, wherein the conductive layer entirely overlaps on the display panel.

10. A noise-shielding method for touch display device, comprising:
forming a conductive layer on a display panel;
forming an insulation layer on the conductive layer;
defining an adapting portion for a ground pad on the insulation layer;
removing parts of the insulation layer corresponding to the adapting portion to form a first via through the insulation layer; and
forming the ground pad on the insulation layer, wherein the ground pad contacts the conductive layer through the first via, so that the conductive layer is grounded.

11. The noise-shielding method for touch display device according to claim 10, wherein the conductive layer entirely overlaps on the display panel.

12. A noise-shielding method for touch display device, comprising:
forming a conductive layer on a display panel;
forming an insulation layer on the conductive layer;
forming a ground pad on the insulation layer, wherein the ground pad defines an opening therethrough;
forming an isolated layer on the ground pad;
removing parts of the isolated layer corresponding to the opening of the ground pad and parts of the insulation layer corresponding to the opening of the ground pad so as to form a first via through the insulation layer and a second via through the isolated layer; and
forming an electrode layer on the isolated layer, wherein the electrode layer comprises a conducting portion corresponding to the ground pad, the conducting portion is electrically connected to the ground pad and the conductive layer through the second via, the opening, and the first via, so that the conductive layer is grounded.

13. The noise-shielding method for touch display device according to claim 12, wherein
the conductive layer entirely overlaps on the display panel.
